(19) United States
(12) Patent Application Publication
(10) Pub. No.: US 2005/0132154 A1
(43) Pub. Date: Jun. 16, 2005

(54) Reliable leader election in storage area network

(75) Inventors: Sudhir G. Rao, Beaverton, OR (US); Robert M. Rees, Los Gatos, CA (US); Randal C. Burns, Washington, DC (US); Darrell D. E. Long, Soquel, CA (US)

Correspondence Address: LIEBERMAN & BRANDSDORFER, LLC, 12221 MCDONALD CHAPEL DRIVE, GAITHERSBURG, MD, 20878, US

(73) Assignee: International Business Machines Corporation, Armonk, NY (US)

(21) Appl. No.: 10/678,858

(22) Filed: Oct. 3, 2003

(51) Int. Cl. G06F 12/00; G06F 15/16; G06F 13/00

(52) U.S. Cl. 711/162; 709/201

(57) ABSTRACT

A method and system for election of a cluster leader in a storage area network is provided Each node in a grouping of storage area network nodes communicates with each of the nodes on a periodic basis to determine if any of the nodes have failed (42). In the event of a cluster fault, each node may request a position of cluster leader. A pruning protocol (60) is invoked to ensure efficient convergence of a single cluster leader candidate to favor a majority grouping leader candidate to become the new cluster leader. In the event the leader candidate from the majority grouping has failed to become the new cluster leader, a minority grouping leader candidate can become the cluster leader. Following the pruning protocol, a voting protocol (100) is invoked followed by lock of the quorum disk (138) by the elected cluster leader candidate.

### BACKGROUND OF THE INVENTION

1. Technical Field

This invention relates to election of a cluster leader in a storage area network More specifically, the invention relates to reliable election of a cluster leader subsequent to loss of a prior cluster leader or loss of communication with the prior cluster leader.

2. Description of the Prior Art

A storage area network (“SAN”) is an increasingly popular storage technology. FIG. 1 is a prior art diagram 5 illustrating a SAN 15 with two clusters of server nodes 10 and 20, and multiple clients 30, 32, and 34. Each node within one of the clusters 0 and 20 is a computer running a single or multiple operating system instances. Each node in a cluster is connected to storage media. A cluster is a set of one or more nodes coordinating access to a set of shared storage subsystems, typically through a storage area network. As shown in FIG. 1, the first cluster 10 includes two nodes 12 and 14, and the second cluster 20 includes four nodes 22, 24, 26, and 28. Each of the clusters 10 and 20 operates as a single homogenous cluster environment. In the configuration shown here, both the nodes 12 and 14 in the first cluster 10, and the nodes 22, 24, 26, and 28 in the second cluster are individually connected to the shared storage system 15. The interconnection of each of the nodes in the first cluster and each of the nodes in the second cluster 20 with the shared storage system 15, allows each of the nodes in the clusters 10 and 20 to access the shared storage system. In a cluster environment, the cluster provides a particular service to the clients. Accordingly, FIG. 1 is an illustration of one form of a cluster environment showing the connection of each of the nodes in each cluster to the shared storage system together with connection of each client to a local area network in communication with the clusters of nodes.

Each cluster of nodes has a cluster leader that owns certain tasks for which member nodes in the cluster require communication with the leader to support a desired service. A loss of operation of the cluster leader or loss of communication between one or more nodes in the cluster and the cluster leader requires a new leader to be elected to ensure cluster integrity. The leader election procedure needs to meet four criteria: (1) reliability or near-certainty of electing a leader, (2) uniqueness of cluster leader, (3) presenting optimal capacity and availability from the cluster to the clients, and (4) choosing a leader in the shortest duration of time. The cluster only needs one leader for correctness of service that the cluster provides, of which the leader needs to be elected with near certainty to avoid cluster unavailability and disruption of service to the clients. Efficient and effective operation of the cluster requires the capacity supported by the cluster to include the maximum number of nodes that can reliably provide service to the clients.

Prior art solutions for leader election fail to meet the four criteria outlined above. Some cluster leader solutions choose the node(s) that first discovered the loss of the leader or loss of connectivity with the leader as the candidate(s) for the new leadership position. Most monitoring techniques for clusters involve one or two nodes that are adjacent to the leader as the nodes to monitor the connectivity with the cluster leader. In this example, the reliability of electing a cluster leader reduces as a result of fault scenarios under which the monitoring nodes might also be handicapped along with the previous leader at about the same time as the leader. In addition, the monitoring nodes may not be well connected to a majority of the nodes. This would result in reducing the chances of optimal capacity being provided to the clients of the cluster. Accordingly, there are limitations associated with this prior art technique of selecting the nodes to monitor connectivity with the cluster leader, in which the selected nodes would also function as subsequent cluster leader candidates in the event of loss of connectivity with the cluster leader.

Another known cluster leader election solution is known as a backoff protocol. There are two variations in this protocol. In both variations, one node tells the remaining nodes to backoff from undertaking the subsequent leader election protocol. If a node does not receive a single backoff message in the random-backoff case or is biased in favor relative to the node sending it a backoff, then the node proceeds to undertake the subsequent leader election protocol. This node may undergo a fault, thus reducing reliability. Accordingly, the backoff protocol does not ensure high reliability for leader election, does not guarantee optimal cluster capacity, and does not mitigate time to converge on a new cluster leader.

Another known prior art solution is known as the majority vote protocol. There are two variations to this protocol a single voting phase protocol and a mulit-phase voting protocol. Both variations require that a new cluster leader receive votes from a majority of the nodes based upon the original quantity of nodes in the cluster. Either variation of the majority voting protocol could be preceded by nomination of a candidate for leader election by predefined or dynamic methods, of which the dynamic methods include the prior art solutions discussed in the preceding paragraphs. These solutions cannot tolerate faults during the protocol or the protocol takes a long time to converge. Accordingly, this process does not ensure high availability of leader election, cluster leader availability under all circumstances, or time efficient for cluster leader election.

Another known leader election solution is the quorum resource lock protocol. There are several variations to this protocol of which one variation uses the quorum resource as an additional vote in the majority vote protocol. Another variation is known as a challenge defense protocol wherein the entire SCSI bus is reset to unlock the quorum resource. The SCSI bus reset is disruptive to all nodes, and the algorithm also take a long time to converge on the leader. The challenge defense protocol utilizes algorithms that require time to converge with multiple nodes attempting to acquire the lock. As such the challenge defense protocol is both disruptive and slow to converge.

Finally, another known prior art solution combines the quorum resource lock and majority vote protocols to provide an extra vote for the node that owns the quorum resource lock to break a tie during a network partition that evenly split the cluster of nodes. However, this solution neither to keeps the cluster available for the newly elected leader before concluding the protocol, nor does it take into account cluster availability via client reachability.

The prior art solutions for electing a new cluster leader in the event of loss of the leader or loss of communication between the nodes and the leader do not satisfy all of the requirements of a cluster election algorithm. Accordingly, a fast and reliable method and system for the election of a single and unique cluster leader with as many of the remaining nodes participating in such a multi-node cluster environment is desired.

### SUMMARY OF THE INVENTION

This invention comprises an algorithm for election of a cluster leader subsequent to a fault in the cluster.

In a first aspect, a method is provided for leader election in a multi-node storage area network The method includes each node communicating to all nodes within a cluster of storage area network nodes of loss of connectivity between a node in the cluster and a cluster leader. A quantity of cluster leader candidates is pruned in response to the loss of connectivity. Approval of the node leadership election is validated within the cluster of nodes to function as a new cluster leader. The validation step includes biasing cluster reformation for election of the new cluster leader based upon a majority grouping of nodes with the cluster of nodes, and/or connectivity with a select group of clients in communication with the cluster.

In a second aspect of the invention, a storage area network system is provided with a group of storage area network nodes including one node adapted to function as a cluster leader. A communication manager is provided to enable each node to inform all nodes within a cluster of nodes of loss of connectivity between a node in the cluster and the cluster leader. A pruning protocol adapted to mitigate a quantity of cluster leader candidates is provided in response to the loss of connectivity. A validation protocol that is adapted to approve a new cluster leader candidate in response to the pruning protocol is also provided. The validation protocol preferably biases cluster leader election from a majority grouping of nodes within the cluster of nodes and/or connectivity with a select group of clients in communication with the cluster.

In a third aspect of the invention, an article in a computer-readable signal-bearing medium is provided Means in the medium are provided for informing all nodes within a cluster of storage area network nodes of loss of communication between a node in the cluster and the cluster leader. Means in the medium are provided for mitigating a quantity of cluster leader candidates responsive to the loss of communication. In addition, means in the medium are provided for validating election of a new cluster leader in response to the mitigation of cluster leader candidates. The means for validation election of a new cluster leader preferably biases cluster leader election from a majority grouping of nodes within the cluster of nodes and/or connectivity with a select group of clients in communication with the cluster.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a shared storage subsystem system in a multi cluster environment

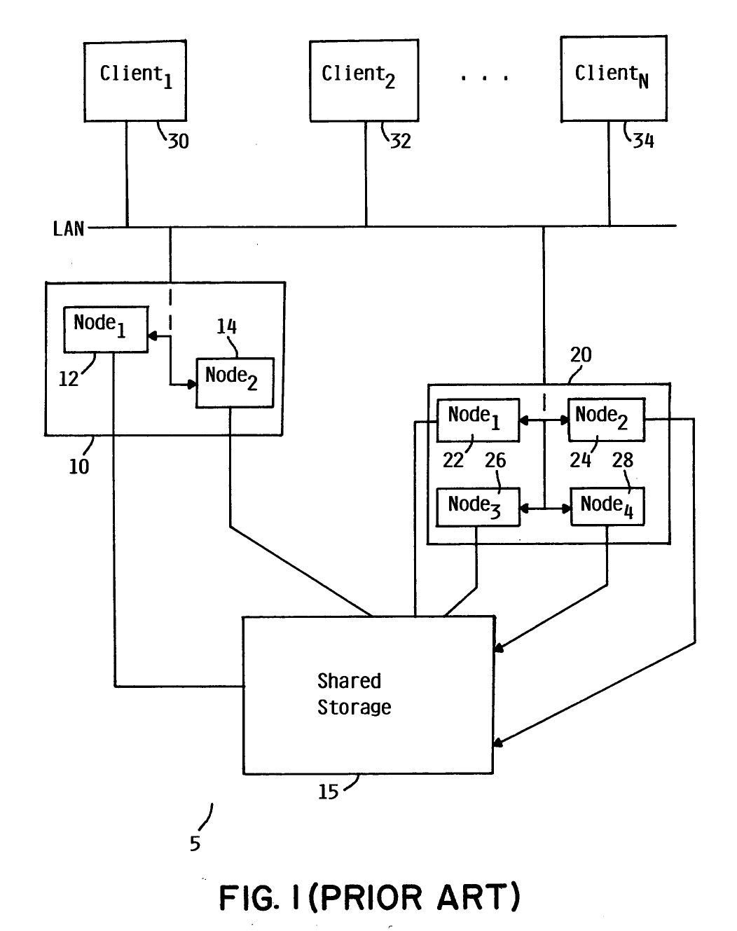

FIG. 2 is a flow chart illuminating node communication fault oversight.

FIG. 3 is a flow chart illustrating the pruning protocol according to the preferred embodiment of this invention, and is suggested for printing on the first page of the issued patent

FIG. 4 is a flow chart illustrating the two pass voting protocol.

FIG. 5 is a flow chart illustrating the quorum disk lock phase.

### DESCRIPTION OF THE PREFERRED EMBODIMENT

### Overview

A cluster of nodes typically has two or more nodes, wherein each node may operate under a single or multiple operating system instances. Each node in a cluster has a unique identifier, known as a node identifier, in the form of a distinct non-negative number. The node identifier satisfies an ordering property in the cluster. The process of electing a new cluster leader subsequent to a loss of communication with a former cluster leader invokes the use of the node identifiers in an ordering protocol. In addition, a two pass system is utilized to ensure that in the event of a partition of the cluster, a new cluster leader may be elected from either a majority or minority grouping of nodes.

### Technical Details

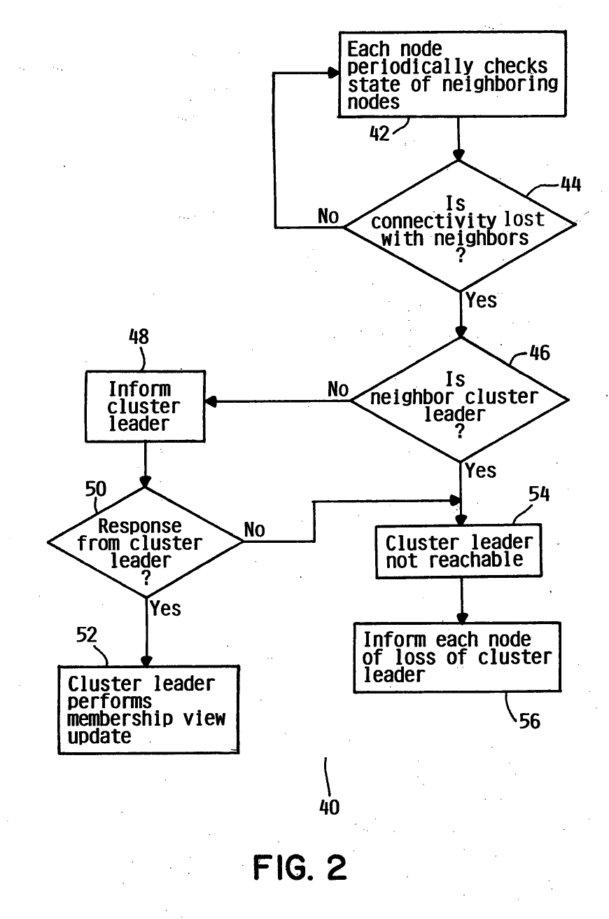

FIG. 2 is a flow chart 40 illustrating the process of detecting loss of communication with any node in the cluster, including the cluster leader node. The fist step in detecting the loss with any node or the cluster leader is for each node to periodically monitor the state of operation of neighboring nodes 42. In a preferred embodiment, heartbeat messages are periodically sent to neighboring nodes for the monitoring process. Following step 42, a test is conducted to determine if any of the nodes in the cluster have ceased communicating with any of the neighboring nodes 44. If the response to the test at step 44 is negative, this is an indication that each node is in communication with the neighboring nodes in the cluster. After a predetermined time interval, the process will return to step 42 to repeat the monitoring process. However, if the response to the test at step 44 is positive for any of the nodes in the cluster, this is an indication that there is a fault in the cluster. There are different types of cluster faults. For example, the cluster leader node may have been subject to a fault associated with the hardware, software, or a network card. Each of these faults would result in the availability of a single cluster grouping with all of the remaining nodes in the cluster reachable from other surviving nodes of the cluster. Another type of fault is a network fault which would result in partition of the cluster into two disjointed grouping of nodes, wherein nodes within a grouping would be in communication only with other nodes in the grouping, i.e. two cluster groupings may have been formed with nodes within a grouping being in communication only with other nodes in the same grouping. Following a determination at step 44 that there is a loss of connectivity in the cluster, a test is conducted to determine if the neighboring node is the cluster leader 46. If the fault resides in an individual node aside from the cluster leader, the cluster leader is sent a message regarding the fault associated with the individual node in the cluster 50. Thereafter, a test is conducted to determine if the informing node has received a response from the cluster leader 50. If a response from the cluster leader is received, the cluster leader performs a membership view update 52. However, if a response from the cluster leader is not received, this is an indicated that the cluster leader is not reachable 54. Similarly, if the response to the test at step 46 is positive, this is another indication that the cluster leader is not reachable 54. Each node that is aware of the cluster fault sends a communication to all remaining nodes in the cluster informing them of the cluster er fault 56. In the event of a loss of communication with the cluster leader subject to a network fault, each node will eventually become aware of the loss of the cluster leader since the cluster leader's neighbors or a neighbor in the other group will inform everyone. Accordingly, the first step in electing a cluster leader is to determine if there is a loss of communication in the cluster between any set of neighboring nodes.

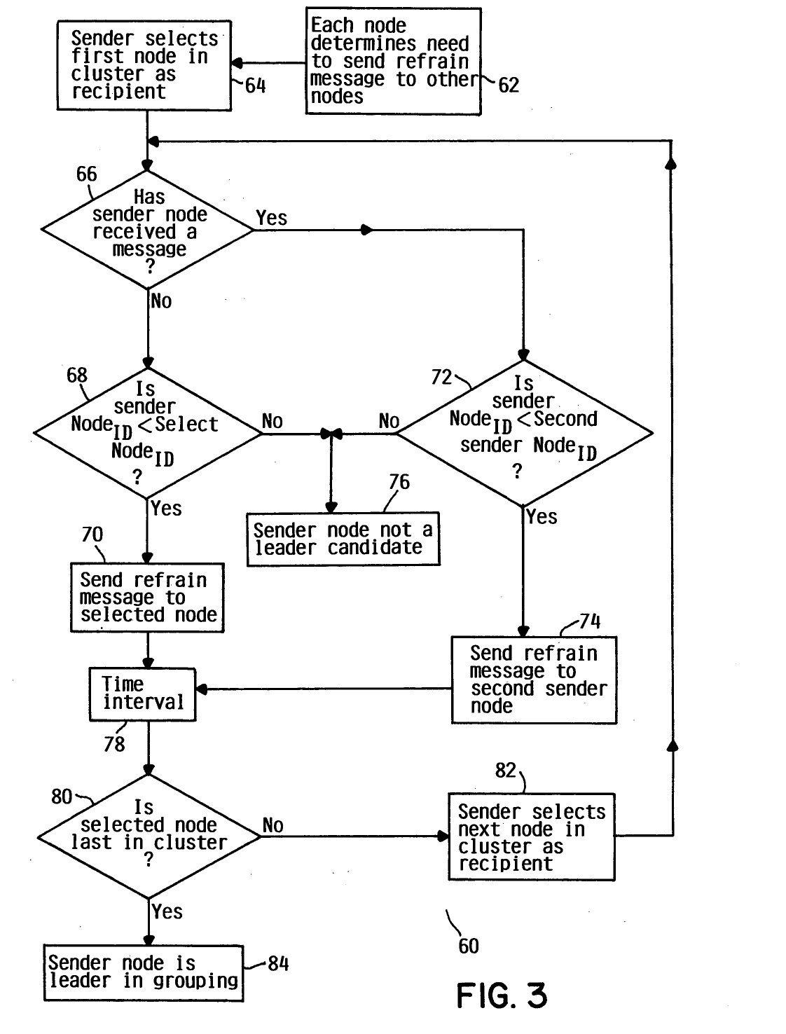

Following a cluster fault, each node in the cluster or the cluster partition, will have an opportunity to become the new cluster leader through a process for selection of a cluster leader candidate that utilizes node identifiers as a tool in the selection process, thus increasing the reliability of leader election. In order to mitigate the time for election of a new cluster leader, a pruning algorithm is invoked. FIG. 3 is a flow chart 60 illustrating the process of mitigating a quantity of cluster leader candidates among a grouping of nodes. The pruning algorithm functions to reduce the quantity of cluster leader candidates in an efficient and timely manner. Each node raining in the cluster subsequent to loss of the cluster leader will have an opportunity to become the new cluster leader.

The pruning process is initiated by each node determining the need to send a refrain message to other nodes in the system 62, and then selecting a first node in the cluster as a recipient of the refrain message 64. Following the selection process at step 64, a test is conducted to determine if the sender node has received a refrain message 66. If the response to the test at step 66 is negative, a subsequent query is conducted to determine if the sender node identifier is less than the selected node identifier 68. A positive response to the test at step 68 will result in the sender node sending a message to the selected node to refrain from vying for the position as the new cluster leader 70. Similarly, if the response to the test at step 66 is positive, this is indicative that the sending node has received a message from a second sender node. A subsequent query is conducted to determine if the sending node identifier is less than the second sender node identifier 72. A positive response to the test at step 72 will result in the sending node sending a message to the second sender node to refrain from vying for the position as the new cluster leader 70. However, a negative response to either the query at steps 68 or 72, is evidence that the sender node is not a cluster leader candidate 76. A node that is determined not to be a cluster leader candidate will become a participant in the voting process initiated by a leader candidate selected from the pruning protocol. Alternatively, following steps 70 and 74, the sending node will wait for a defined time interval 78 before continuing through the pruning protocol Upon conclusion of the time interval at step 78, a test is conducted to determine if the node selected to receive a message at step 64 is the final node in the cluster 80. A negative response to the test at step 80, will result in the sending node selecting a subsequent node in the cluster as a recipient of a refrain message 82. Thereafter, the node proceeds to step 66 to determine if the node selected at step 82 should receive a refrain message. Alternatively, if the response to the test at step 80 is positive, the sending node is determined to be the cluster leader candidate from the grouping of nodes in which the sending node continues to maintain communication 84. Accordingly, the process for selection of a cluster leader candidate utilizes the node identifiers as a tool in the selection process.

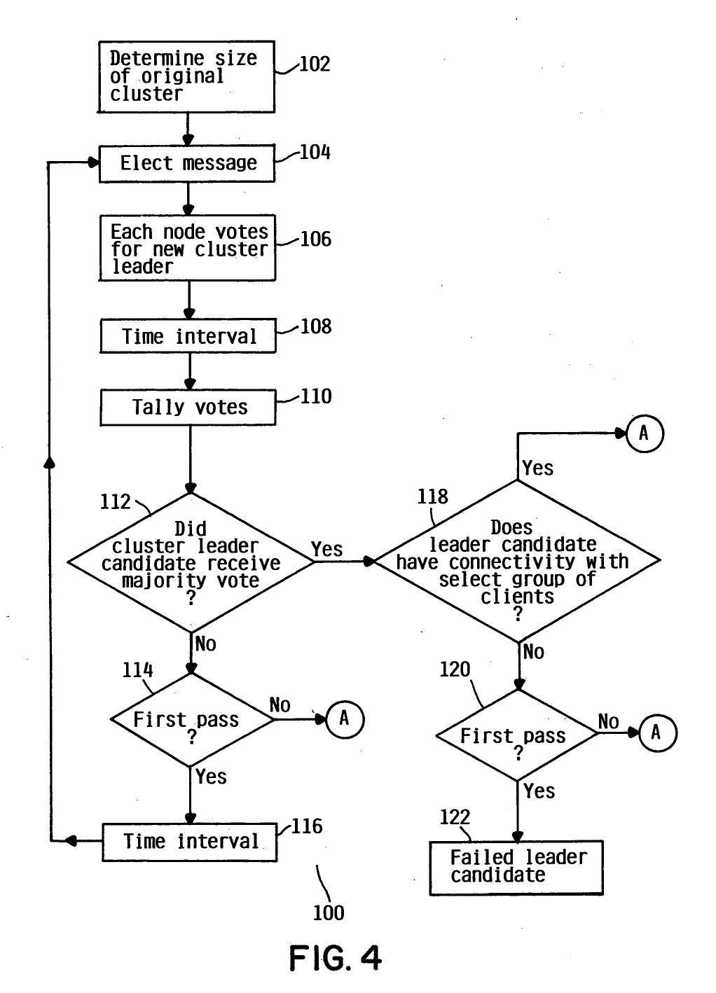

Following the process of pruning the quantity of nodes for the position of new cluster leader candidate, a cluster leader must be established. FIG. 4 is a flow chart 100 illustrating the process of electing a new cluster leader. The election process invokes a two pass protocol to ensure that a cluster leader is preferably selected from majority grouping of nodes, and alternatively from a minority grouping of nodes. The first step in the election process is to determine the size of the original cluster of nodes 102, N. A majority quantity of nodes in a grouping is determined by the following equation:
Majority Grouping=[Truncate(N/2)]+1 Equation 1
,wherein N is the quantity of nodes in the original cluster of nodes. Thereafter, a first pass of a vote for election of a new cluster leader is invoked. This process establishes that a leader of a grouping of nodes from the process illustrated in FIG. 3 can establish a majority or minority grouping status. In addition, the first pass of a vote validates the ability of a leader of a grouping of nodes to continue in the process of leadership election for the cluster. A message is sent to each of the remaining nodes in the group with instructions to vote for the cluster leader node candidate as the leader of the grouping of nodes 104. Each of the nodes in the grouping that has received the message from step 104 votes for a new cluster leader 106, and the responses are counted 110 following a time interval 108. Following the vote tally at step 110, a test is conducted to determine if the cluster leader candidate for the grouping received a majority of the votes 112, as defined in Equation 1, based upon the original size of the cluster. Accordingly, the first part of the election protocol of FIG. 4 involves each of the nodes in the cluster voting for a cluster leader candidate.

The cluster leader election process allows for a maximum of two passes through the voting process. A negative response to the test at step 112 in FIG. 4 will result in a test to determine if the vote was a first pass or a second pass 114. If the vote was the first pass, a time interval 116 is invoked to bias favor of the election for a node from a majority grouping of nodes. Following the time interval at step 116, a second pass for a cluster leader candidate from a minority grouping of nodes is conducted 104. The first step in the second pass includes a time delay to allow a cluster leader candidate from a majority grouping of the nodes a first try at acquiring a quorum disk lock. Thereafter, the second pass of the election process returns to step 114 for completion of the election process from the minority grouping of nodes. Following election of a cluster leader from a minority grouping of nodes, there will be two candidates for the new cluster leader. Accordingly, the election process favors election of a new cluster leader from a majority grouping of nodes, while accommodating election of a new cluster leader from a minority grouping of nodes.

However, if at step 112 a cluster leader candidate received a majority vote, the cluster leader candidate must then determine if it has connectivity with a select group of clients which the cluster has been or is intended to service 118. A positive response to the determination at step 118 will allow the cluster leader candidate to proceed to a quorum disk lock phase. However, a negative response to the determination at step 118 results in a subsequent query to determine if the vote at step 106 was the first pass or second pass of the election 120. If the vote at step 106 was the first pass, then the cluster leader candidate is a failed candidate 122. However, if the vote at step 106 was a second pass, the election protocol proceeds to a quorum disk lock phase. Accordingly, the election process accounts for a determination as to whether the cluster leader candidate has received votes from a majority grouping of nodes, as well as whether the cluster leader candidate continues to have connectivity with a select group of clients.

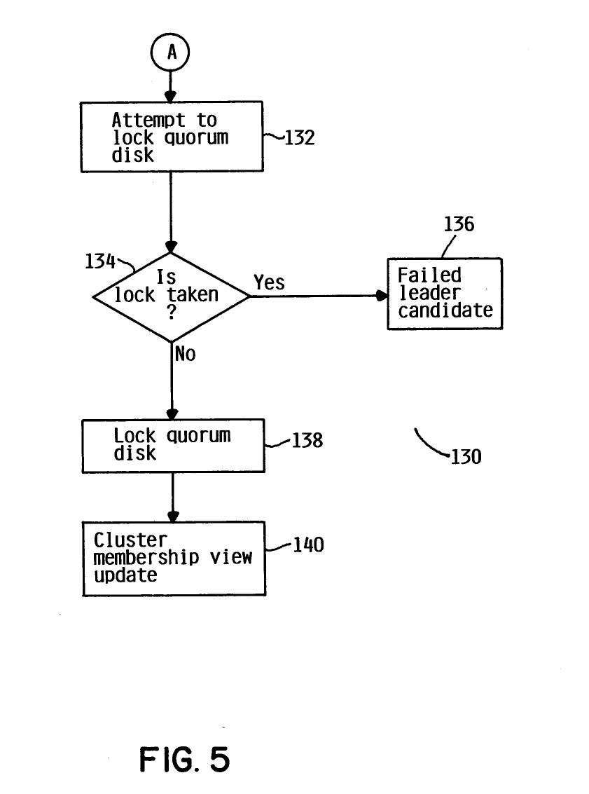

FIG. 5 is a flow chart 130 illustrating the process of a cluster leader candidate acquiring quorum disk lock. This phase is initiated following a second pass for election of a cluster leader candidate, or if the cluster leader candidate received a majority of votes based on Equation 1 during the first pass. The first step in the process of acquiring a lock on the quorum disk is to attempt to lock the quorum disk for exclusive cluster leadership 132. Thereafter, a test is conducted to determine if a lock on the quorum disk is already in existence 134. A positive result for the test at step 134 is an indication that the elected leader candidate for the grouping of nodes failed at its attempt to lock the quorum disk 136. The grouping of nodes associated with the failed cluster leader candidate will require an administrative repair action for the grouping to rejoin the cluster. Alternatively, if the response to the test at step 134 is negative, the cluster leader candidate from the grouping of nodes locks the quorum disk 138. The cluster leader candidate is now the new cluster leader and the grouping of nodes in communication with the new cluster leader represents the cluster. Following acquisition of the quorum disk lock, an update of the cluster membership view across the cluster is conducted 140. Accordingly, the final process of election of a new cluster leader is the acquisition of the quorum disk lock.

### Advantages Over the Prior Art

The process of election of a new cluster leader following a cluster fault provides increased reliability of leader election and cluster reformation. A pruning protocol based upon a hierarchical system of the node identifiers is used to elect a new leader candidate for a grouping of nodes in a short duration. Thereafter, a two pass system is invoked to optimize a higher capacity cluster subset that has connectivity with a select group of clients, if possible, and to provide a highly diminished cluster subset in the event of unavailability of the former. The two pass system favors the majority grouping that also has good client connectivity as this would increase cluster capacity that is available to its clients. However, in the event a cluster leader is elected from a minority grouping of nodes, this ensures that a cluster leader is elected and the cluster can function and operate, although on a less efficient basis. Accordingly, the pruning protocol together with the two pass system ensures operation of the cluster with a cluster leader in a reliable and efficient manner following a fault in the cluster.

### Alternative Embodiments

It will be appreciated that, although specific embodiments of the invention have been described herein for purposes of illustration, various modifications may be made without departing from the spirit and scope of the invention. In particular, the quorum disk is provided in a shared storage system in which the grouping nodes communicate for data. The algorithm for election of a cluster leader in the event of a cluster fault is a shared protocol. Any correct and reliable algorithm may be used for the quorum disk lock protocol. The candidate for cluster leader has an exclusive hold of the quorum disk resource for a required time period. In addition, this cluster leader election algorithm is applicable to any cluster environment in communication with a shared storage media in which the nodes in the cluster have access to the shared storage. Accordingly, the scope of protection of this invention is limited only by the following claims and their equivalents.

1. A method of leader election in a multi-node storage area network, comprising:
(a) each node communicating to all nodes within a cluster of storage area network nodes of loss of connectivity between a node in said cluster and a cluster leader,
(b) pruning a quantity of cluster leader candidates in response to loss of connectivity; and
(c) validating approval of node leadership election within said cluster of nodes to function as a new cluster leader.

2. The method of claim 1, wherein the step of pruning cluster leader candidates includes a recipient node of said communication requesting a node with a higher identifier node value to refrain from requesting a position of new cluster leader candidate.

3. The method of claim 1, further comprising determining if said new leader candidate is from a majority grouping of said nodes within said cluster of nodes.

4. The method of claim 1, wherein the step of poling cluster leader candidates includes mitigating time to convergence of election of said new cluster leader.

5. The method of claim 1, wherein the step of validating approval of node leadership election within said cluster of nodes to function as a new cluster leader includes biasing cluster reformation from a group consisting of: a majority grouping of nodes within said cluster of nodes, and connectivity with a select group of clients in communication with said cluster, and combinations thereof.

6. The method of claim 5, further comprising requiring additional time for election of said node leader candidate from a minority grouping of nodes within said cluster of nodes.

7. The method of claim 1, further comprising the step of electing said new cluster leader candidate from a minority grouping of nodes within said cluster of nodes upon failure of a cluster leader candidate from a majority grouping of nodes, wherein said failure is selected from a group consisting of lock of said quorum disk, and said cluster leader candidate, and combinations thereof.

8. The method of claim 1, further comprising election a node within a connected grouping of nodes to function as a new leader candidate, wherein said node is selected from a group consisting of a majority connected grouping of nodes and a minority connected grouping of nodes.

9. A storage area network system comprising:
a group of storage area network nodes with one node adapted to function as a cluster leader,
a communication manager to enable each node to inform all nodes within a cluster of nodes of loss of connectivity between a node in said cluster and said cluster leader,
a pruning protocol adapted to mitigate a quantity of cluster leader candidates in response to the loss of connectivity; and
a validation protocol adapted to approve a new cluster leader in response to said pruning protocol.

10. The system of claim 9, wherein said pruning protocol includes an informed node adapted to petition all nodes within said group of nodes with a higher node identifier to refrain from a request for position of cluster leader.

11. The system of claim 9, wherein said validation protocol includes a determination of origination of said cluster leader candidate from a majority grouping of said nodes.

12. The system of claim 9, wherein said validation protocol is adapted to bias cluster reformation from a group consisting of: a majority grouping of nodes within said cluster of nodes, and connectivity with a select group of clients in communication with said cluster, and combinations thereof.

13. The system of claim 9, further comprising an election manager adapted to enable election of said new cluster leader candidate from a group consisting of: a majority connected grouping of nodes, and a minority connected grouping of nodes.

14. The system of claim 13, wherein said election manager is responsive to failure of a cluster leader candidate from a majority grouping of nodes to acquire a quorum disk lock.

15. An article comprising:
a computer-readable signal-rig medium;
means in the medium for informing all nodes within a cluster of storage area network nodes of loss of communication between a node in said cluster and a cluster leader,
means in the medium for mitigating a quantity of cluster leader candidates responsive to said loss of communication; and
means in the medium for validating election of a new cluster leader responsive to mitigation of said quantity of candidates.

16. The article of claim 15, wherein the medium is selected from a group consisting of; a recordable data storage medium, and a modulated carrier signal.

17. The article of claim 15, wherein said means for informing all nodes of loss of communication with a cluster leader includes a communication manager.

18. The article of claim 15, wherein said means for mitigating a quantity of cluster leader candidates includes a pruning protocol adapted to petition all informed nodes with a higher node identifier to refrain from a request for a new cluster leader position.

19. The article of claim 15, wherein said means for validating election of a new cluster leader includes a validation protocol adapted to bias cluster reformation from a group consisting of: a majority grouping of nodes within said cluster of nodes, and connectivity with a select group of clients in communication with said cluster, and combinations thereof.

20. The article of claim 15, wherein said new cluster leader is selected from a group consisting of: a majority connected grouping of nodes, and a minority connected grouping of nodes.
